(19) United States
(12) Patent Application Publication
(10) Pub. No.: US 2019/0305318 A1
(43) Pub. Date: Oct. 3, 2019

(54) NON-AQUEOUS BATTERY ELECTRODE PLATE, NON-AQUEOUS BATTERY AND METHOD FOR MANUFACTURING NON-AQUEOUS ELECTRODE PLATE

(71) Applicant: PRIMEARTH EV ENERGY CO., LTD., Kosai-shi (JP)

(72) Inventor: Junya HISHII, Kosai-shi (JP)

(73) Assignee: PRIMEARTH EV ENERGY CO., LTD., Kosai-shi (JP)

(21) Appl. No.: 16/287,849

(22) Filed: Feb. 27, 2019

(30) Foreign Application Priority Data
Mar. 27, 2018 (JP) 2018-059750

(51) Int. Cl. H01M 4/62; H01M 10/0525; H01M 4/04; H01M 4/131; H01M 4/1391; H01M 4/36; H01M 4/485

(52) U.S. Cl. CPC H01M 4/628; H01M 10/0525; H01M 4/0404; H01M 4/043; H01M 2004/028; H01M 4/131; H01M 4/1391; H01M 4/364; H01M 4/485; H01M 4/0471

(57) ABSTRACT

A non-aqueous battery electrode plate including a collector and an electrode composite material layer located on the collector. The electrode composite material layer includes first particles containing an active material and second particles that are smaller than the first particles and formed from a water-repellent material. The first particles and the second particles are mixed in a thickness-wise direction of the electrode layer. The electrode composite material layer further includes a region in which the second particles are concentrated. The region includes a surface of the electrode composite material layer at a side opposite to the collector.

### BACKGROUND

The following description relates to a non-aqueous battery electrode plate including an electrode composite layer located on a collector, a non-aqueous battery, and a method for manufacturing a non-aqueous battery electrode plate.

A lithium-ion rechargeable battery, which is one example of a non-aqueous battery, includes a lithium composite oxide that serves as positive electrode active material. In a process for manufacturing a lithium-ion rechargeable battery, when filling the battery with a non-aqueous electrolyte, active material including a lithium composite oxide may come into contact with the water in the air. Contact of the active material with air decomposes the non-aqueous electrolyte and accelerates the generation of lithium carbonate. This adversely affects the repetitive characteristics of the battery and the storage characteristics of the battery under high temperatures. In this regard, Japanese Laid-Open Patent Publication Nos. 2007-280830 and 2012-043658 each describe a lithium-ion rechargeable battery that covers the surface of particles containing active material with a water-repellent coating.

However, the manufacturing process of the lithium-ion rechargeable battery applies pressure to a positive electrode composite material layer to adjust the layer thickness in accordance with the specification of the battery. This may crack or delaminate the water-repellent coating. As a result, there is still room for improvement with regard to limiting contact of the particles containing active material with water. In addition to lithium-ion batteries, the same applies to batteries using non-aqueous electrolytes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a non-aqueous battery electrode plate including a collector and an electrode composite material layer located on the collector. The electrode composite material layer includes first particles containing an active material and second particles that are smaller than the first particles and formed from a water-repellent material. The first particles and the second particles are mixed in a thickness-wise direction of the electrode composite material layer. The electrode composite material layer further includes a region in which the second particles are concentrated. The region includes a surface of the electrode composite material layer at a side opposite to the collector.

A further aspect of the present disclosure is a method for manufacturing a non-aqueous battery electrode plate including an electrode composite material layer located on a collector. The method includes applying a coating to the collector and forming the electrode composite material layer by drying the coating. The coating includes a solvent, first particles containing an active material, and second particles that are smaller than the first particles and formed from a water-repellent material. The forming the electrode composite material layer includes drying the coating so that the first particles and the second particles are mixed in the electrode composite material layer in a thickness-wise direction and so that the second particles are concentrated in a region including a surface of the electrode composite material layer.

Other features and aspects will be apparent from the following detailed description, the drawings, and the claims.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a lithium-ion battery according to one embodiment of the present invention;

FIG. 2 is a plan view showing the layer construction of an electrode plate in the lithium-ion battery of FIG. 1;

FIG. 3 is a schematic cross-sectional view showing the distribution of particles in a positive electrode composite material layer according to the embodiment;

FIG. 4 is a flowchart showing the steps for manufacturing the electrode plate according to the embodiment; and

FIG. 5 is a diagram showing a drying step performed when manufacturing the positive electrode plate according to the embodiment.

### DETAILED DESCRIPTION

One embodiment of a non-aqueous battery electrode plate, a non-aqueous battery, and a method for manufacturing a non-aqueous battery electrode plate will now be described. In the description hereafter, the non-aqueous battery electrode plate is embodied in a positive electrode plate of a lithium-ion battery electrode plate, and the non-aqueous battery is embodied in a lithium-ion rechargeable battery.

Lithium-Ion Rechargeable Battery 10

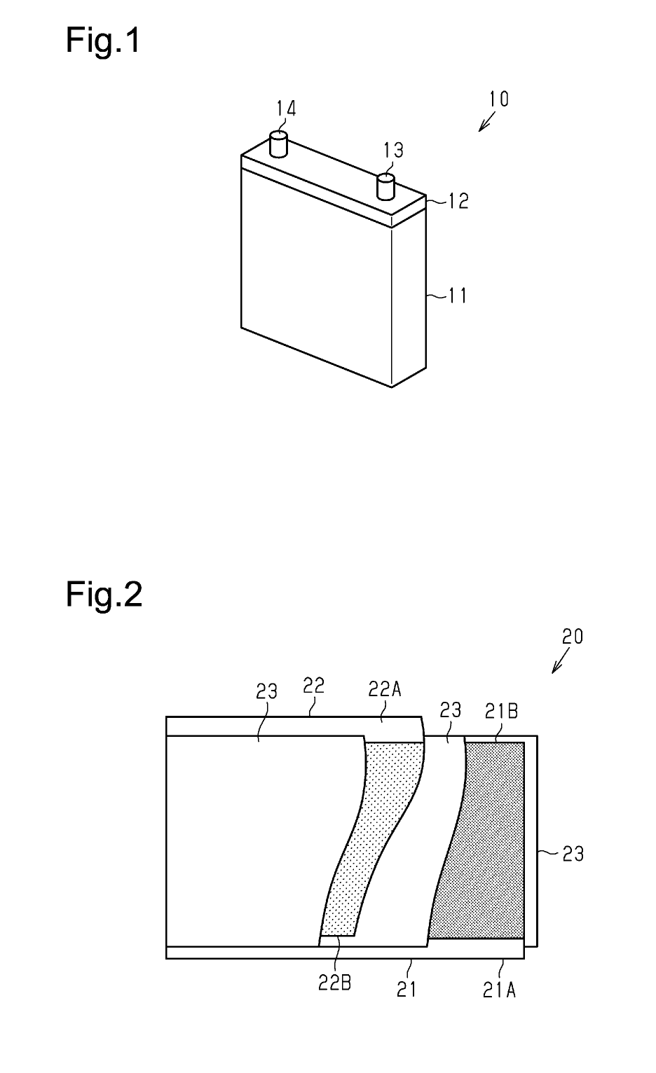

As shown in FIG. 1, a lithium-ion rechargeable battery 10 includes a case 11 and a lid 12 closing the opening of the case 11. The lid 12 includes a positive electrode terminal 13 and a negative electrode terminal 14. The case 11 accommodates an electrode body 20 (refer to FIG. 2) and a non-aqueous electrolyte. The non-aqueous electrolyte is a non-aqueous electrolyte such as a non-aqueous electrolyte including a lithium-containing electrolyte or a known non-aqueous electrolyte such as a polymer electrolyte, or a polymer gel electrolyte.

The electrode body 20 is a stack of a positive electrode plate 21, a negative electrode plate 22, and a separator 23. The separator 23 is held between the positive electrode plate 21 and the negative electrode plate 22. That is, the electrode body 20 is formed by stacking the positive electrode plate 21, the separator 23, and the negative electrode plate 22 in order one after another. FIG. 2 is a plan view showing the layer construction of the electrode body 20 in a state in which some of the layers are cut away.

The positive electrode plate 21 includes a positive electrode collector 21A and two positive electrode composite material layers 21B located on opposite sides of the positive electrode collector 21A. The positive electrode collector 21A is one example of a collector, and each of the positive electrode composite material layers 21B is one example of an electrode composite material layer. The positive electrode terminal 13 is connected to a portion of the positive electrode collector 21A separated from the positive electrode composite material layers 21B.

The negative electrode plate 22 includes a negative electrode collector 22A and two negative electrode composite material layers 22B located on opposite sides of the negative electrode collector 22A. The negative electrode terminal 14 is connected to a portion of the negative electrode collector 22A separated from the negative electrode composite material layers 22B. The electrode body 20 is accommodated in the case 11 as, for example, a winding wound in the longitudinal direction.

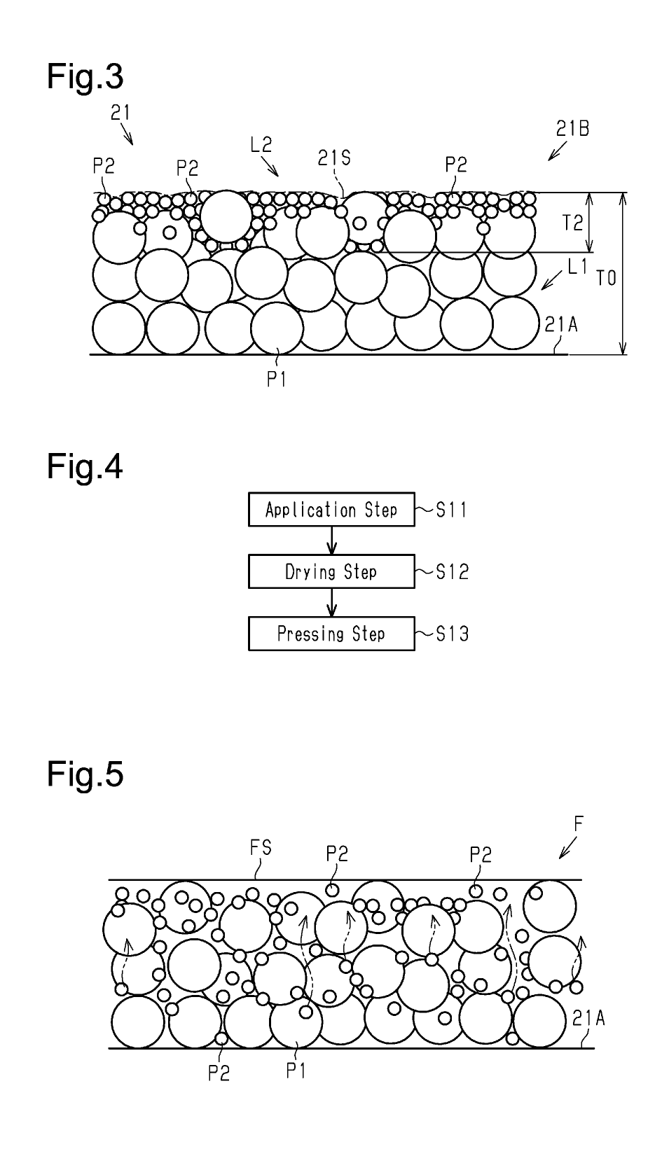

The material forming the positive electrode collector 21A includes, for example, aluminum or an aluminum alloy. The material forming the positive electrode composite material layers 21B includes first particles P1 (refer to FIG. 3), which contain a lithium composite oxide that is a positive electrode active material, and second particles P2, which are formed from a water-repellent material. In addition to the first particles P1 and the second particles P2, the material forming the positive electrode composite material layers 21B includes a binding agent and a conducting agent.

The lithium composite oxide is a material that stores and releases lithium. The lithium composite oxide is an oxide including lithium and a metal element other than lithium. A metal element other than lithium is, for example, at least one selected from a group consisting of nickel and cobalt. Further, a metal element other than lithium is at least one selected from a group consisting of manganese, vanadium, magnesium, molybdenum, niobium, titanium, tungsten, aluminum, and iron included as iron phosphate in a lithium composite oxide.

For example, the lithium composite oxide is lithium cobalt oxide (LiCoO₂), lithium nickel oxide (LiNiO₂), or lithium manganese oxide (LiMn₂O₄). For example, lithium composite oxide is a ternary lithium composite oxide, specifically, and lithium nickel cobalt manganese oxide (LiNiCoMnO₂). For example, the lithium composite oxide is lithium iron phosphate (LiFePO₄). Lithium cobalt oxide, lithium nickel oxide, and lithium nickel cobalt manganese oxide have layered constructions and a higher reactivity than lithium iron phosphate.

The conducting agent expands a conductance path of electrons between the first particles P1 thereby lowering the reaction resistance of the positive electrode composite material layers 21B. The conducting agent is a carbon material such as graphite, acetylene black, or carbon fibers.

The binding agent binds each first particle P1 with the other first particles P1. The binding agent is, for example, ethylene propylene diene monomer (EPDM), styrene-butadiene rubber (SBR), acrylonitrile butadiene rubber (NBR), polyvinyl acetate, polymethylmethacrylate, polyethylene, or a cellulose nitrate such as cellulose nitrate.

The water-repellent material repels water that comes into contact with the surface of the positive electrode composite material layers 21B. The water-repellent material is, for example, a fluoric resin selected from at least one of polyvinylidene difluoride (PVDF), a copolymer that can be copolymerized with PVDF, polytetrafluoroethylene (PTFE), fluorinated polyvinylidene difluoride, and fluoro-rubber. The water repellent material functions to bind each first particle P1 with other first particles P1.

The material forming the negative electrode collector 22A includes, for example, copper or nickel. The material forming the negative electrode composite material layers 22B includes particles containing a negative active material, a binding agent, and a conducting agent. The negative electrode active material is, for example, carbon such as graphite, a lithium metal, or a lithium alloy. The binding agent is, for example, SBR or denatured SBR.

Positive Electrode Composite Material Layers 21B

As shown in FIG. 3, in the positive electrode composite material layers 21B, the first particles P1 are mixed with the second particles P2 in the thickness-wise direction of the positive electrode composite material layers 21B. Each positive electrode composite material layer 21B includes a surface 21S located at the side opposite to the positive electrode collector 21A. The second particles P2 are distributed in the thickness-wise direction of the positive electrode composite material layer 21B and concentrated in a region including the surface 21S of the positive electrode composite material layers 21B. The region in which the second particles P2 are concentrated has a predetermined thickness and includes portions in which the first particles P1 and the second particles P2 are mixed in the thickness-wise direction. The second particles P2 are increased in number from the positive electrode collector 21A toward the surface 21S. The surface 21S of the positive electrode composite material layer 21B is water-repellent because of the concentration of the second particles P2. The water repellency of the surface 21S has a characteristic in which the water contact angle is 15° or greater. The water contact angle is measured through a static process complying with JIS R3257 (1999) and obtained after thirty seconds elapses from when water falls.

When observing a cross section of the positive electrode composite material layer 21B in the thickness-wise direction, the ratio of the second particles P2 occupying the cross-sectional unit area is the highest at the surface 21S of the positive electrode composite material layers 21B. The ratio of the second particles P2 occupying the cross section decreases from the surface 21S of the positive electrode composite material layer 21B toward the positive electrode collector 21A. The second particles P2 may be located in the surface 21S of the positive electrode composite material layers 21B but does not have to be located in the surface 21S of the positive electrode composite material layers 21B.

Generally, when covering the surface 21S of the positive electrode composite material layer 21B with the second particles P2, after the application of a coating including the first particles P1, a water-repellent layer of the second particles P2 may be applied. In this case, the water-repellent layer is applied over the coating including the first particles P1. This forms a layer of the first particles P1 and a separate layer of the second particles P2. Thus, the second particles P2 exist only in the surface 21S of the positive electrode composite material layer 21B. When using a substance such as PVDF as the binding agent for the second particles P2 like in the present embodiment, the second particles P2 will exist inside the positive electrode composite material layer 21B in addition to the surface 21S of the positive electrode composite material layers 21B. This increases the degree of adhesion between particles.

The first particles P1 have an average particle diameter (two-dimensional particle diameter) that is, for example, greater than 5 μm and less than or equal to 10 μm. The second particles P2 have an average particle diameter (two-dimensional diameter) that is smaller than the average diameter of the first particles P1, for example, 3 μm or greater and 5 μm or less. If the average diameter of the second particles P2 is 3 μm or greater, the second particles P2 will have sufficient water repellency. If the average diameter of the second particles P2 is 5 μm or less, when forming the positive electrode composite material layer 21B, the second particles P2 can be moved toward the surface 21S together with the vaporization of the organic solvent. The average diameter of the first particles P1 and the average diameter of the second particles P2 is, for example, a volume-based median diameter (D50:50% volume average diameter) and obtained through known measurement processes such as a laser diffraction-scattering process.

The second particles P2 are also located between the first particles P1 that are adjacent to one another. When observing the cross section of the positive electrode composite material layer 21B in the thickness-wise direction, the ratio of the second particles P2 occupying a cross-sectional unit area is higher at portions closer to the surface 21S of the positive electrode composite material layers 21B. That is, when observing the cross section of the positive electrode composite material layer 21B in the thickness-wise direction, the ratio of the area of the second particles P2 to the area of the first particles P1 is higher at portions closer to the surface 21S of the positive electrode composite material layer 21B. Thus, the water-repelling effect produced by the second particles P2 increases at portions closer to the surface 21S of the positive electrode composite material layers 21B. Further, the functions required for the positive electrode composite material layer 21B are sufficiently obtained inside the positive electrode composite material layers 21B where the water-repelling effect of the second particles P2 is not required, in particular, at the vicinity of the positive electrode collector 21A.

Further, in one example of the gaps between the first particles P1, the gaps between the first particles P1 are larger at portions closer to the surface 21S of the positive electrode composite material layer 21B. Further, the ratio of the first particles P1 occupying the cross-sectional unit area, that is, the density of the first particles P1 in a cross section extending in the thickness-wise direction of the positive electrode composite material layer 21B decreases at portions closer to the surface 21S of the positive electrode composite material layer 21B. Larger gaps between the first particles P1 increases the amount of the second particles P2 located between the first particles P1. When the density of the first particles P1 decreases at portions closer to the surface 21S, the second particles P2 can easily be arranged in lieu of the first particles P1 at portions closer to the surface 21S. Thus, the second particles P2 can easily be concentrated in the surface 21S.

In the positive electrode composite material layer 21B, the region where the second particles P2 do not exist is defined as an active material region L1. In the positive electrode composite material layer 21B, the region where the second particles P2 exist is referred to as the water-repellent region L2. The ratio of the thickness T2 of the water-repellent region L2 to the thickness TO of the positive electrode composite material layers 21B is, for example, 25% or less. The thickness TO of the positive electrode composite material layers 21B is, for example, 20 μm. The thickness T2 of the water-repellent region L2 is, for example, 5 μm. As long as the thickness T2 of the water-repellent region L2 is 25% or less of the thickness TO of the positive electrode composite material layers 21B, it is possible to sufficiently suppress that the progress of the reaction at the first particles P1 is hindered by the second particles P2 inside the positive electrode composite material layer 21B while obtaining the water-repelling effect with the second particles P2. Further, the water-repellent region L2 limits increases in the diffusion distance of components used for battery reactions.

When observing the cross section of the positive electrode composite material layer 21B in the thickness-wise direction, the determination of whether or not the second particles P2 exist is performed through elemental mapping that is based on electron probe micro-analysis (EPMA). The elements subject to elemental mapping are elements existing only in the second particles P2 of the positive electrode composite material layers 21B such as fluorine. The EPMA conducted on the positive electrode composite material layers 21B is performed through a method that is in compliance with JIS K0190 (2010). In the EPMA, the range less than or equal to the detection limit is a range in which the second particles P2 do not exist.

In the surface 21S of the positive electrode composite material layer 21B, the ratio of the second particles P2 per unit area is, for example, 50% or less. In the surface 21S of the positive electrode composite material layer 21B, the regions other than that of the second particles P2 are occupied by, for example, the first particles P1, the binding agent, or the conducting agent. In this case, the determination of whether or not the second particles P2 exist is performed through elemental mapping based on EPMA. As long as the surface area of the water-repellent region L2 is 50% or less of the surface area of the positive electrode composite material layer 21B, the water-repelling effect can be obtained with the second particles P2 while allowing for sufficient reaction of the first particles P1 in the vicinity of the surface of the positive electrode composite material layer 21B.

Generally, when covering the surface 21S of the positive electrode composite material layer 21B with the second particles P2, a water-repellent layer of the second particles P2 may be formed subsequent to the application of the positive electrode composite material layer 21B. In such a case, the ratio of the second particles P2 in the surface 21S is at least 90% or greater and close to 100%. In such a case, the surface 21S is formed by the second particles P2 that have a lower electric conductance than the first particles P1. This may increase the battery resistance. In this respect, the second particles P2 occupy only a portion of the surface 21S in the present embodiment. This limits increases in the battery resistance.

Further, in one example of the gaps between the first particles P1, more conducting agent may be filled in the gaps between the first particles P1 if the gaps are larger. That is, at portions closer to the surface of the positive electrode composite material layer 21B, the density of the first particles P1 is low, the density of the second particles P2 is high, and the density of particles smaller than the first particles P1 such as the conducting agent is high. As long as the density of the conducting agent increases at portions closer to the surface 21S, an increase in the battery resistance resulting from the concentration of the second particles P2 can be limited.

Method for Manufacturing Positive Electrode Plate 21

As shown in FIG. 4, a method for manufacturing the positive electrode plate 21 includes an application step of forming a coating on the positive electrode collector 21A (step S11), a drying step of forming the positive electrode composite material layers 21B (step S12), and a pressing step of pressing the positive electrode composite material layers 21B (step S13).

The application step applies a liquid composition (slurry or paste) to the surface of the positive electrode collector 21A to form a coating. The application of the liquid composition is performed using an application device such as a slit coater, a die coater, or a gravure coater. The liquid composition includes the first particles P1, the second particles P2, a conducting agent, a binding agent, a viscosity improver, and an organic solvent. The viscosity improver is, for example, an N-methyl-2-pyrrolidone (NMP) solution of polyvinylidene difluoride (PVDF). The organic solvent is, for example, NMP, N,N-dimethylacetamide, N,N-dimethyl sulfoxide, or hexamethylphosphoramide.

The liquid composition has a solid ratio of, for example, 30 mass % or greater and 90 mass % or less, preferably, 40 mass % or greater and 70 mass % or less. The ratio of the first particles P1 to the entire solid is, for example, 50 mass % or greater and 95 mass % or less, preferably, 75 mass % or greater and 95 mass % or less. The ratio of the second particles P2 to the entire solid is 1 mass % or greater and 10 mass % or less. The ratio of the conducting agent to the entire solid is, for example, 2 mass % or greater and 20 mass % or less, preferably, 2 mass % or greater and 15 mass % or less. The ratio of the viscosity improver to the entire solid is, for example, 1 mass % or greater and 10 mass % or less, preferably, 2 mass % or greater and 5 mass % or less. In one example, the ratio of the first particles P1 to the entire solid is 55 mass %, the ratio of the second particles P2 to the entire solid is 1 mass %, and the ratio of additives such as the conducting agent, the binding agent, and the viscosity improver to the entire solid is 44 mass %.

The drying step vaporizes the organic solvent included in the coating and dries the coating so that the second particles P2 are concentrated in the surface 21S of the positive electrode composite material layer 21B. The organic solvent is vaporized through, for example, natural drying, drying performed by feeding currents of hot air or low-humidity air, drying performed by placing the coating in a vacuum, drying performed by irradiating the coating with infrared or far infrared, or a combination of these drying processes. The temperature of the coating when dried is higher than the temperature for uniformly distributing the second particles P2 throughout the positive electrode composite material layer 21B. The time required to dry the coating is shorter than the time required to uniformly distribute the second particles P2 throughout the positive electrode composite material layer 21B.

For example, when using NMP as the organic solvent and 1 mass % of PVDF particles as the second particles P2, the temperature for uniformly distributing the second particles P2 throughout the positive electrode composite material layers 21B is 140° C. or greater and 160° C. or less. As long as the temperature of the coating when drying the coating is 140° C. or greater and 160° C. or less, the NMP can be sufficiently vaporized and dried. In this regard, the inventors of the present invention have found that a further increase in temperature when vaporizing the NMP can move the second particles P2 in the coating toward the surface 21S of the positive electrode composite material layer 21B. More specifically, as long as the particle diameter of the second particles P2 is 3 μm or greater and 5 μm or less, the second particles P2 can be moved toward (concentrated in) the surface 21S by setting the temperature of the coating when dried to 170° C. or greater and 190° C. or less.

In this case, as shown in FIG. 5, the organic solvent included in a coating F is vaporized from a surface FS of the coating F. Further, the organic solvent located in the vicinity of the positive electrode collector 21A moves through gaps between the first particles P1 to the surface FS of the coating F. The drying performed at a high temperature for a short period of time results in the second particles P2 located in the vicinity of the positive electrode collector 21A being drawn toward the surface FS of the coating F following the movement of the organic solvent. This allows the second particles P2 to be concentrated in the surface of the positive electrode composite material layer 21B.

Further, the gaps between adjacent ones of the first particles P1 are larger at portions closer to the surface of the positive electrode composite material layer 21B. For example, as shown in FIG. 5, vaporization of the organic solvent draws the second particles P2 toward the surface. Thus, the second particles P2 are not caught between the first particles P1 at portions close to the surface of the collector. In contrast, a large number of the second particles P2 are caught between the first particles P1 at portions close to the surface of the positive electrode composite material layers 21B. This results in the gaps between the first particles P1 being larger at portions closer to the surface of the positive electrode composite material layers 21B. Further, the ratio of the first particles P1 occupying a cross-sectional unit area extending in the thickness-wise direction decreases at portions closer to the surface of the positive electrode composite material layer 21B. The vaporization of the organic solvent also draws the conducting agent included in the coating F toward the surface. This increases the density of the conducting agent at portions closer to the surface of the positive electrode composite material layer 21B in the same manner as the second particles P2.

The pressing step applies pressure to the positive electrode composite material layer 21B to adjust the thickness of the positive electrode composite material layer 21B. The pressing step is performed through, for example, a compression process such as roll pressing process or a flat pressing process. The second particles P2 concentrated in the surface 21S of the positive electrode composite material layers 21B disperses the stress applied to the surface 21S. This reduces cracking and delamination of the positive electrode composite material layer 21B.

The above embodiment has the advantages described below.

(1) The second particles P2 concentrated in the surface 21S of the positive electrode composite material layers 21B cover the first particles P1. Further, the water repellency of the second particles P2 limits contact between the first particles P1 and water. The second particles P2 concentrated in the surface 21S also disperse the stress applied to the surface 21S and limits deterioration of the water repellency resulting from the application of stress.

(2) Particularly, in the pressing step that adjusts the thickness of the positive electrode composite material layer 21B, the second particles P2 allows for dispersion of the stress applied to the surface 21S of the positive electrode composite material layer 21B. This limits deterioration of the water repellency in the positive electrode composite material layers 21B resulting from the application of stress.

(3) When the ratio of the second particles P2 occupying the cross-sectional unit area is higher at portions closer to the surface 21S, the water repellency effect produced by the second particles P2 is enhanced at portions closer to the surface 21S. As a result, the entrance of water is limited at the surface 21S of the positive electrode composite material layer 21B. Further, the first particles P1 enhance electrode reaction produced in the vicinity of the positive electrode collector 21A. This limits changes in the input-output characteristics caused by the second particles P2.

(4) As long as the thickness of the water-repellent region L2 is 25% or less of the thickness of the positive electrode composite material layer 21B, the second particles P2 do not hinder reaction of the first particles P1 inside the positive electrode composite material layers 21B while also obtaining advantage (1).

(5) As long as the surface area of the water-repellent region L2 is 50% or less of the surface area of the positive electrode composite material layer 21B, the first particles P1 produce sufficient reaction in the vicinity of the surface of the positive electrode composite material layers 21B while also obtaining advantage (1).

(6) The second particles P2 function to bind the first particles P1. This increases the strength joining the water-repellent region L2 and the first particles P1.

It should be apparent to those skilled in the art that the present invention may be embodied in many other specific forms without departing from the spirit or scope of the invention. Particularly, it should be understood that the present invention may be embodied in the following forms.

The ratio of the second particles P2 occupying the cross-sectional unit area extending in the thickness-wise direction may be the highest at a location other than the surface of an electrode composite material layer. For example, the ratio of the second particles P2 occupying the cross-sectional unit area extending in the thickness-wise direction may be the highest in the vicinity of the surface of an electrode composite material layer such as at a portion located toward the collector from the surface of the electrode composite material layer by an amount corresponding to the average diameter of the first particles P1. The portion where the second particles P2 are located may be changed by the drying temperature or the drying time in the drying step.

In this manner, a non-aqueous battery electrode plate only needs to have the second particles P2 be more concentrated in the surface of the electrode composite material layer than the surface of the collector, with the second particles P2 concentrated in a region including the surface of the electrode composite material layer.

The pressing step may be omitted from the method for manufacturing a non-aqueous battery electrode plate. A manufacturing method that does not include the pressing step also obtains advantages (1) to (5).

The electrode composite material layer need only be located on at least one side of the collector and may be located on one side of a foil-like collector.

The shape of the collector may be set in correspondence with the shape of the non-aqueous battery. For example, the collector may be a foil, a sheet, a plate, a rod, or a mesh.

Non-aqueous batteries include both primary batteries and rechargeable batteries.

A non-aqueous battery includes an electrode body stacking a positive electrode plate and a negative electrode plate located at opposite sides of a separator. The electrode body is impregnated with a non-aqueous electrolyte. The non-aqueous battery may have any shape. For example, the non-aqueous battery may be shaped to have to form of a cylinder or a stack.

The present examples and embodiments are to be considered as illustrative and not restrictive, and the invention is not to be limited to the details given herein, but may be modified within the scope and equivalence of the appended claims.

1. A non-aqueous battery electrode plate comprising:
a collector;
an electrode composite material layer located on the collector, wherein
the electrode composite material layer includes
first particles containing an active material,
second particles that are smaller than the first particles and formed from a water-repellent material, wherein the first particles and the second particles are mixed in a thickness-wise direction of the electrode composite material layer, and
a region in which the second particles are concentrated, wherein the region includes a surface of the electrode composite material layer at a side opposite to the collector.

2. The non-aqueous battery electrode plate according to claim 1, wherein
the second particles are located between the first particles in the region and distributed in the thickness-wise direction of the electrode composite material layer, and
a ratio of the second particles occupying a cross-sectional unit area extending in the thickness-wise direction is the highest at a surface of the electrode composite material layer.

3. The non-aqueous battery electrode plate according to claim 1, wherein a ratio of the second particles occupying the cross-sectional unit area is 50% or less in a surface of the electrode composite material layer.

4. The non-aqueous battery electrode plate according to claim 1, wherein a ratio of the first particles occupying a cross-sectional unit area is smaller and a gap between the first particles is larger at portions closer to the surface of the electrode composite material layer.

5. The non-aqueous battery electrode plate according to claim 1, wherein
the second particles exist in the electrode composite material layer in a water-repellent region, and
a ratio of a thickness of the water-repellent region to a thickness of the electrode composite material layer is 25% or less.

6. The non-aqueous battery electrode plate according to claim 1, wherein the second particles are located between the first particles in the region and bind the first particles.

7. A non-aqueous battery comprising:
the non-aqueous battery electrode plate according to claim 1, and
a non-aqueous electrolyte.

8. A method for manufacturing a non-aqueous battery electrode plate including an electrode composite material layer located on a collector, the method comprising:
applying a coating to the collector; and
forming the electrode composite material layer by drying the coating, wherein
the coating includes a solvent, first particles containing an active material, and second particles that are smaller than the first particles and formed from a water-repellent material,
the forming the electrode composite material layer includes drying the coating so that the first particles and the second particles are mixed in the electrode composite material layer in a thickness-wise direction and so that the second particles are concentrated in a region including a surface of the electrode composite material layer.

9. The method according to claim 8, wherein
the solvent is N-methyl-2-pyrrolidone,
the second particles have a particle diameter of 3 μm or greater and 5 μm or less
the coating is dried at a temperature of 170° C. or greater and 190° C. or less.

10. The method according to claim 8, further comprising pressing the electrode composite material layer.
